(19) United States
(12) Patent Application Publication
(10) Pub. No.: US 2015/0213580 A1
(43) Pub. Date: Jul. 30, 2015

(54) DISPLAY CONTROL APPARATUS, DISPLAY CONTROL METHOD, PROGRAM, AND DISPLAY DEVICE

(71) Applicant: SONY CORPORATION, Tokyo (JP)

(72) Inventors: IKUO YAMANO, TOKYO (JP); HIROYUKI MIZUNUMA, TOKYO (JP); AYUMI KATO, TOKYO (JP)

(21) Appl. No.: 14/597,643

(22) Filed: Jan. 15, 2015

(30) Foreign Application Priority Data
Jan. 28, 2014 (JP) 2014-013625

(51) Int. Cl. G06T 3/60; G06F 3/0346; G06F 1/16

(52) U.S. Cl. CPC G06T 3/60; G06F 1/163; G06F 3/0346

(57) ABSTRACT

There is provided a display control apparatus including a controller configured to control display on a display device worn on an arm of a user. The controller acquires position information indicative of a position of a display region for display in the display device and controls display on the display region depending on the acquired position information.

### CROSS REFERENCE TO RELATED APPLICATIONS

This application claims the benefit of Japanese Priority Patent Application JP 2014-013625 filed Jan. 28, 2014, the entire contents of which are incorporated herein by reference.

### BACKGROUND

The present disclosure relates to a display control apparatus, a display control method, a program, and a display device. Wearable terminals that are operatively worn on the body of users have been recently developed. For example, U.S. Patent Application Publication 20130044215 A1 discloses a bracelet-type device that is available as a wearable terminal operatively worn on the arm of users.

### SUMMARY

Such bracelet-type device as described above is equipped with a display unit for displaying various types of information. The display unit has a limited size in terms of user's convenience. Meanwhile, the user takes various postures by moving his arm on which a bracelet-type device is worn. In this case, the user may have difficulty in viewing information displayed on the display unit depending on the posture of the arm. No adequate measures for this difficulty are provided so far.

Therefore, an embodiment of the present disclosure provides a method of performing display that is more easily visible to a user in a display device worn on the arm of the user.

According to an embodiment of the present disclosure, there is provided a display control apparatus including a controller configured to control display on a display device worn on an arm of a user. The controller acquires position information indicative of a position of a display region for display in the display device and controls display on the display region depending on the acquired position information.

According to another embodiment of the present disclosure, there is provided a display control method including acquiring position information indicative of a position of a display region for display in a display device worn on an arm of a user, and controlling display on the display region by a processor depending on the acquired position information.

According to still another embodiment of the present disclosure, there is provided a program for causing a computer to execute acquiring position information indicative of a position of a display region for display in a display device worn on an arm of a user, and controlling display on the display region depending on the acquired position information.

According to yet another embodiment of the present disclosure, there is provided a display device including a display region for display, and a controller configured to control display on the display region. The display device is worn on an arm of a user. The controller acquires position information indicative of a position of the display region in the display device and controls display on the display region depending on the acquired position information.

According to one or more embodiments of the present disclosure as described above, it is possible to perform display that is more easily visible to a user in a display device worn on the arm of the user.

Note that the advantages described above are not necessarily intended to be restrictive, and any other advantages described herein and other advantages that will be understood from the present disclosure may be achievable, in addition to or as an alternative to the advantages described above.

### BRIEF DESCRIPTION OF THE DRAWINGS

FIG. 1 is a diagram illustrating an exemplary configuration of a bracelet-type terminal 10 according to an embodiment of the present disclosure;

FIG. 2 is a diagram illustrated to describe a state in which the bracelet-type terminal 10 is worn on the arm of a user;

FIG. 3 is a diagram illustrated to describe a state in which a bracelet-type terminal 20 according to a first modification is worn on the arm of a user;

FIG. 4 is a diagram illustrating the configuration of a bracelet-type terminal 30 according to a second modification;

FIG. 5 is a block diagram illustrating an exemplary functional configuration of a display control apparatus 100 according to an embodiment;

FIG. 6 is a diagram illustrated to describe an example of a portrait view and a landscape view of a display unit 12 of the bracelet-type terminal 10;

FIG. 7 is a diagram illustrated to describe an example of a portrait view and a landscape view of a display unit 12 of the bracelet-type terminal 10;

FIG. 8 is a diagram illustrated to describe an example of display to be displayed on a first display unit 22 and a second display unit 26 of the bracelet-type terminal 20;

FIG. 9 is a diagram illustrated to describe an example of display to be displayed on the first display unit 22 and the second display unit 26 during execution of a mailer app;

FIG. 10 is a diagram illustrated to describe an example of display to be displayed on the first display unit 22 and the second display unit 26 during execution of a map app;

FIG. 11 is a diagram illustrated to describe an example of display to be displayed on the first display unit 22 and the second display unit 26 during execution of a video player app;

FIG. 12 is a diagram illustrated to describe an example of display to be displayed on the first display unit 22 and the second display unit 26 during execution of a photo viewer app;

FIG. 13A is a diagram illustrated to describe a modification of display to be displayed on the display unit 12 of the bracelet-type terminal 10;

FIG. 13B is a diagram illustrated to describe another modification of display to be displayed on the display unit 12 of the bracelet-type terminal 10;

FIG. 14A is a diagram illustrated to describe a modification of display to be displayed on the first display unit 22 and the second display unit 26 of the bracelet-type terminal 20;

FIG. 14B is a diagram illustrated to describe another modification of display to be displayed on the first display unit 22 and the second display unit 26 of the bracelet-type terminal 20;

FIG. 15 is a diagram illustrating a smartphone 900 according to a comparative example;

FIG. 16 is a diagram illustrated to describe an example of display to be displayed on the first display unit 22 and the second display unit 26 of the bracelet-type terminal 20 in a meeting or presentation;

FIG. 17 is a diagram illustrated to describe an example of display depending on the position of the display unit 12 of the bracelet-type terminal 10 upon receipt of email;

FIG. 18 is a schematic diagram illustrated to describe an example of an animation during switching from a portrait view to a landscape view;

FIG. 19 is a flowchart illustrating an exemplary operation of the display control apparatus 100 during switching of a display orientation of the display unit; and

FIG. 20 is a diagram illustrated to describe an exemplary hardware configuration of the display control apparatus 100 according to an embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description is made in the following order:
1. Overview of bracelet-type terminal
2. Functional configuration of display control apparatus
3. Example of display
3-1. Portrait view and landscape view
3-2. Example of display to be displayed on display unit during execution of app
3-3. Example of display in consideration of degree of privacy
3-4. Animation in case of switching between portrait and landscape views
4. Operation of display control apparatus
5. Hardware configuration
6. Conclusion

### 1. Overview of Bracelet-Type Terminal

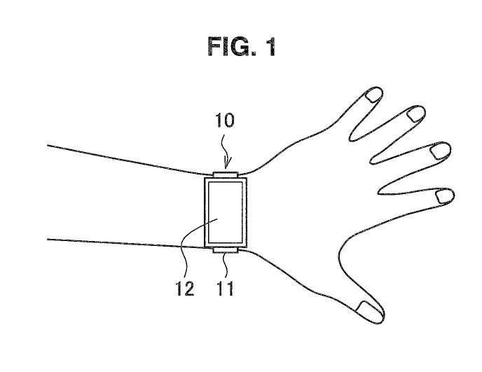

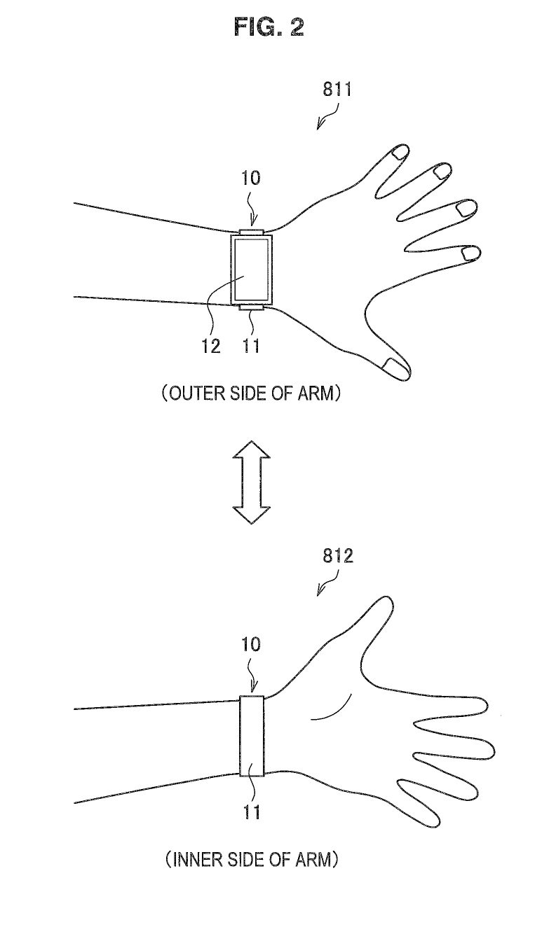

An exemplary configuration of a bracelet-type terminal that is equipped with a display control apparatus according to an embodiment of the present disclosure will be described with reference to FIGS. 1 and 2.

FIG. 1 is a diagram illustrating an exemplary configuration of a bracelet-type terminal 10 according to an embodiment. FIG. 2 is a diagram illustrated to describe a state in which the bracelet-type terminal 10 is worn on the arm of a user. The state 811 shown in FIG. 1 indicates the outer side of an arm on which the bracelet-type terminal 10 is worn. The state 812 shown in FIG. 2 indicates the inner side of an arm on which the bracelet-type terminal 10 is worn. The outer side of the arm refers to a side on which the back of the hand is visible (dorsal aspect), and the inner side of the arm refers to a side on which the palm is visible (palmar aspect).

The bracelet-type terminal 10 is, for example, a wearable device that is worn on the arm or wrist of the user as shown in FIG. 1 or 2. The bracelet-type terminal 10 is also a display device for displaying various types of information in the state where it is worn on the arm or other parts. Such bracelet-type terminal 10 allows the user to check and operate information displayed on a display screen on the spot without taking out the bracelet-type terminal 10 from a bag or pocket.

The bracelet-type terminal 10 is configured to include a belt portion 11 and a display unit 12. The belt portion 11 is a part that is wound around the arm. The display unit 12 is located on one side of the arm of the user to make the display screen easily visible to the user. For example, in FIG. 2, the display unit 12 is located on the outer side of the arm. The user may turn his arm depending on use conditions to cause the display unit 12 to be located from the outer side of the arm to the inner side.

The display unit 12 is a display region that is used in displaying text, images, and other information on a display screen. The display of text, images, and other information on the display unit 12 is controlled by a controller 120 that is described later. Examples of the display unit 12 include liquid crystal displays, organic EL displays, or the like. The display unit 12 has a rectangular shape and has a portrait-oriented screen (a taller-than-wide screen) as shown in FIG. 1. The display unit 12 may have a shape that is curved along the arm of the user.

The display unit 12 may include an operation surface as an operation unit superimposed thereon. The operation surface is a touch panel. In this case, the user performs a touch operation on the operation surface while viewing the display screen of the display unit 12. This makes it possible for the user to select desired information from any information displayed on the display screen.

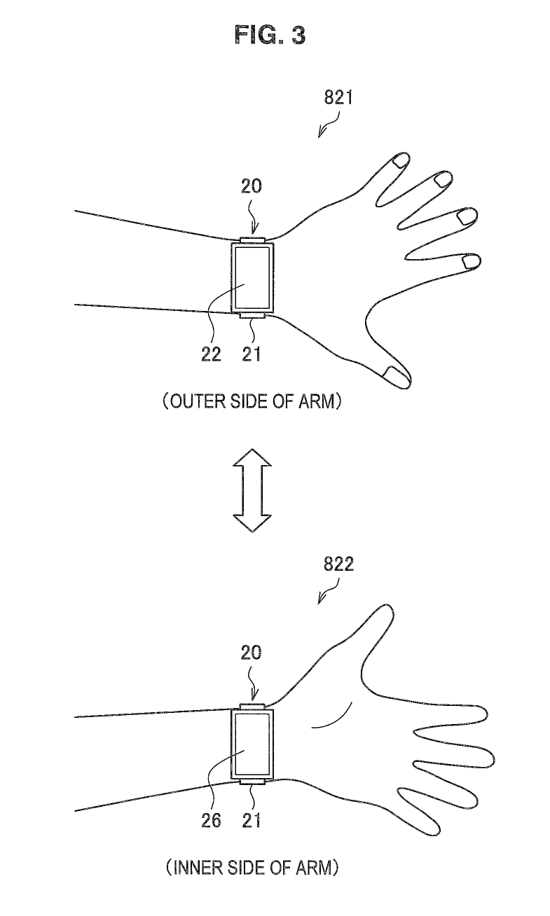

In the above, the display unit 12 is located on one side of the arm as shown in FIG. 2, but the location of the display unit is not limited thereto. For example, the display unit may be each provided on both sides (outer and inner sides) of the arm of the user as shown in FIG. 3.

FIG. 3 is a diagram illustrated to describe a state in which a bracelet-type terminal 20 according to a first modification is worn on the arm of a user. The bracelet-type terminal 20 is configured to include a belt portion 21, a first display unit 22, and a second display unit 26. The belt portion 21 is a part that is wound around the arm. The first display unit 22 and the second display unit 26 are respectively located on either side of the arm. For example, the first display unit 22 is located on the outer side of the arm as shown in the state 821 of FIG. 3, and the second display unit 26 is located on the inner side of the arm as shown in the state 822. In other words, the second display unit 26 is located on the opposite side of the first display unit 22 as viewed from the arm. The first display unit 22 and the second display unit 26 may be allowed to perform display on only one of them or may be allowed to perform display both of them together depending on use conditions of the bracelet-shaped terminal 20. The first display unit 22 corresponds to a first display region, and the second display unit 26 corresponds to a second display region.

In FIG. 3, the first display unit 22 and the second display unit 26 are shown as being separated from each other, but this is not limited thereto. For example, the first display unit 22 and the second display unit 26 may be configured to be connected to each other. In this case, the first display unit 22 and the second display unit 26 are capable of displaying information as a single display unit.

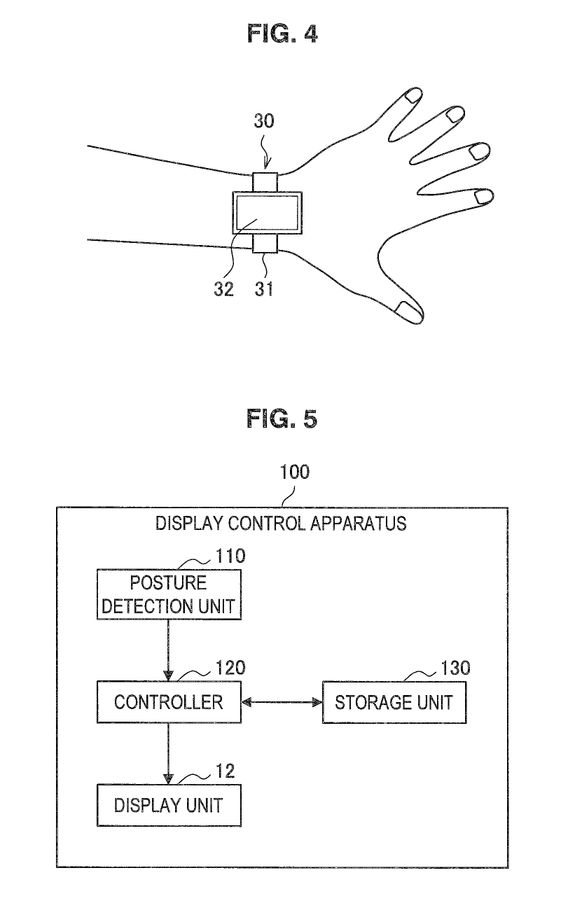

In the above, an example of the bracelet-type terminal 10 including the taller-than-wide display unit 12 is described as shown in FIG. 1, but this is not limited thereto. For example, as shown in FIG. 4, a bracelet-type terminal 30 including a wider-than-tall display unit 32 may be provided. FIG. 4 is a diagram illustrating the configuration of the bracelet-type terminal 30 according to a second modification.

However, in the case of the bracelet-type terminal 30 having a wider-than-tall configuration as shown in FIG. 4, for example, the display unit 32 may be hidden in the sleeves of the garment or the display unit may interferes with movement of the wrist. In consideration of this, it is more preferable to use the bracelet-type terminal 10 or 20 having a taller-than-wide configuration.

### 2. Functional Configuration of Display Control Apparatus

An exemplary functional configuration of a display control apparatus 100 according to an embodiment is described with reference to FIG. 5. FIG. 5 illustrates the display control apparatus 100 that is configured to control the bracelet-type terminal 10 rather than the bracelet-type terminal 20.

FIG. 5 is a block diagram illustrating an exemplary functional configuration of the display control apparatus 100 according to an embodiment. As shown in FIG. 5, the display control apparatus 100 is configured to include a posture detection unit 110, a controller 120, and a storage unit 130, in addition to the display unit 12.

(Posture Detection Unit 110)

The posture detection unit 110 detects the posture of the arm on which the bracelet-type terminal 10 or 20 is worn. For example, the posture detection unit 110 detects a change in the posture due to the turning over or rotation of the arm. The posture detection unit 110 is configured to include, for example, an acceleration sensor or a gyro sensor. The posture detection unit 110 may detect a gesture made with the arm.

(Controller 120)

The controller 120 is a display control unit used to control display to be performed by the bracelet-type terminal 10 that is a display device worn on the arm of the user.

In the present embodiment, the controller 120 acquires position information indicative of the position of the display unit 12 that performs display in the bracelet-type terminal 10, and controls display to be displayed on the display unit 12 depending on the acquired position information. The position information may be acquired based on a detection result obtained by the posture detection unit 110. For example, the controller 120 acquires information on whether the display unit 12 is located on the outer side or on the inner side of the arm.

The controller 120 acquires position information indicative of a position of the display unit 12 with respect to the arm, and controls display to be displayed on the display unit 12 depending on the position of the display unit 12 with respect to the arm. For example, the controller 120 may control a display orientation of the display unit 12 depending on the acquired position information. The orientation of content, which is to be displayed, suitable for the user to view varies depending on the position of the display unit 12. Thus, by controlling display on the display unit 12 depending on the position of the display unit 12 with respect to the arm, the display suitable for the user to view can be performed.

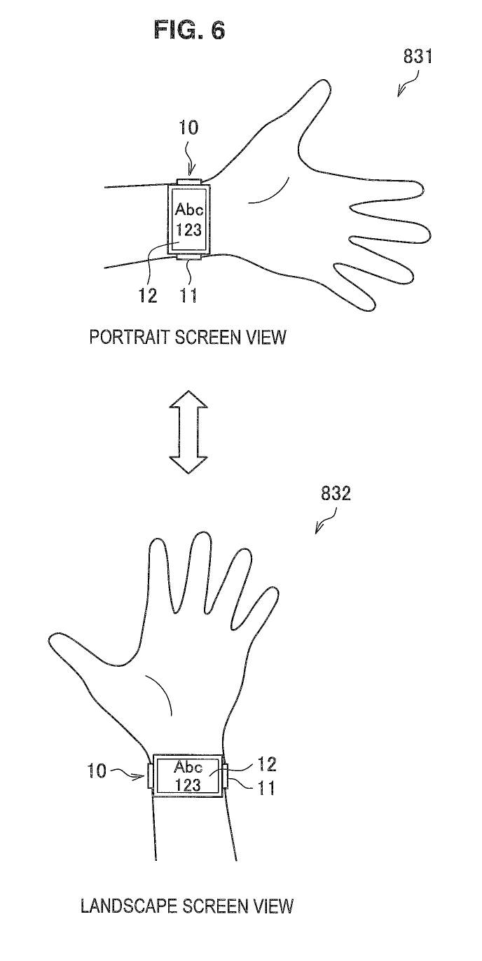

More specifically, the controller 120 may switch a display orientation between a first orientation along the longitudinal direction of the display unit 12 and a second orientation along the short-length direction of the display unit 12 depending on the acquired position information. The display in the first orientation indicates, for example, a portrait view shown in FIG. 6, and the display in the second orientation indicates a landscape view shown in FIG. 6. Thus, when the display unit 12 is located on any one side of the outer and inner sides of the arm, the display unit 12 performs display in the orientation that is more easily visible to the user.

The controller 120, when switching display between the first and second orientations, may allow the orientation of display to be changed in a stepwise manner. For example, the controller 120, when switching from a portrait view to a landscape view, causes content to be displayed as an animation so that the user who views the display unit 12 faces the display content. This makes it possible for the user to easily recognize the content displayed, even in the middle of switching the display.

Furthermore, the controller 120 may control the content displayed on the display unit 12 depending on the acquired position information. For example, the controller 120 may make the content displayed on the display unit 12 located on a first side as viewed from the arm different from the content displayed on the display unit 12 located on a second side opposite to the first side as viewed from the arm. Specifically, when the display unit 12 is located in a position that is easily visible to others, the controller 120 may cause information with a low degree of privacy to be preferentially displayed. When the display unit 12 is located in a position that is hardly visible to others, the controller 120 may cause information with a high degree of privacy to be displayed. This makes it possible to prevent information with a high degree of privacy from being viewed by others.

The controller 120 acquires rotation information regarding rotation of the arm and may control display to be displayed on the display unit 12 depending on the rotation position of the arm. In other words, the controller 120 cause the posture detection unit 110 to detect the rotation position of the arm and thus it may recognize an exact position of the display unit 12, thereby allowing the display unit 12 to perform display suitable for the user to view easily.

Although the control of display to be displayed on the display unit 12 of the bracelet-type terminal 10 has been described in the above, such display control is similarly applicable to the first and second display units 22 and 26 of the bracelet-type terminal 20. In addition, the controller 120 may control display to be displayed on the first and second display units 22 and 26 as described below.

For example, the controller 120 may also make the display orientation of the display unit 22 different from the display orientation of the display unit 26 depending on the acquired position information. When the first display unit 22 and the second display unit 26 are provided opposite to each other as viewed from the arm, the display orientation of the first display unit 22 that is suitable for the user to view is more likely to be different from the display orientation of the first display unit 26 that is suitable for the user to view. The difference between the display orientation of the first display unit 22 and the display orientation of the first display unit 26 allows the first display unit 22 and the second display unit 26 to implement easily viewable display.

Moreover, the controller 120 may make the content displayed on the first display unit 22 different from the content displayed on the second display unit 26 depending on the acquired position information. For example, between the first and second display units 22 and 26, the controller 120 may cause a display unit (for example, the first display unit 22) located on the outer side of the arm to display information with a low degree of privacy, and the controller 120 may cause a display unit (for example, the second display unit 26) located on the inner side of the arm to display information with a high degree of privacy. This makes it possible to prevent information with a high degree of privacy from being viewed by others. The controller 120 may cause the second display unit 26 to display the content in relation to the content displayed on the first display unit 22. For example, the controller 120 causes the first display unit 22 to display a list of emails and causes the second display unit 26 to display the body of an email. This allows for selection of a desired email in the list and for viewing the body of the selected email.

(Storage Unit 130)

The storage unit 130 stores programs that are executed by the controller 120 or information that is necessary for control by the controller 120. For example, the storage unit 130 may store the relationship between the posture of the terminal and the display orientation of the display unit.

In the above configuration, the bracelet-type terminal 10 includes the controller 120, but it is not limited to this configuration. For example, the controller 120 may be provided in a server that is able to communicate with the bracelet-type terminal 10 via a network. In such a case, the controller 120 of the server controls the display to be displayed on the display unit 12 based on the detection result obtained by the posture detection unit 110 of the bracelet-type terminal 10. Thus, the server functions as the display control apparatus.

In the above configuration, the controller 120 automatically controls the display to be displayed on the display region depending on the position of the display region (the display unit 12 or the like), but it is not limited to this configuration. For example, the control may be set so that the user may switch a setting of whether the control is performed or not (ON/OFF), and then when the setting is ON, the control is to be performed. When the setting is OFF, the display on the display region is performed regardless of the position of the display region.

### 3. Example of Display to be Displayed on Display Unit

Examples of display to be displayed on the display unit 12 of the bracelet-type terminal 10 or the first and second display units 22 and 26 of the bracelet-type terminal 20 are described.

### 3-1. Portrait View and Landscape View

Each of the display unit 12, the first display unit 22, and the second display unit 26 is able to display portrait and landscape views that are different display orientations. The switching between a portrait view and a landscape view depending on the posture of the arm on which the bracelet-type terminal 10 or the bracelet-type terminal 20 is worn will be described below.

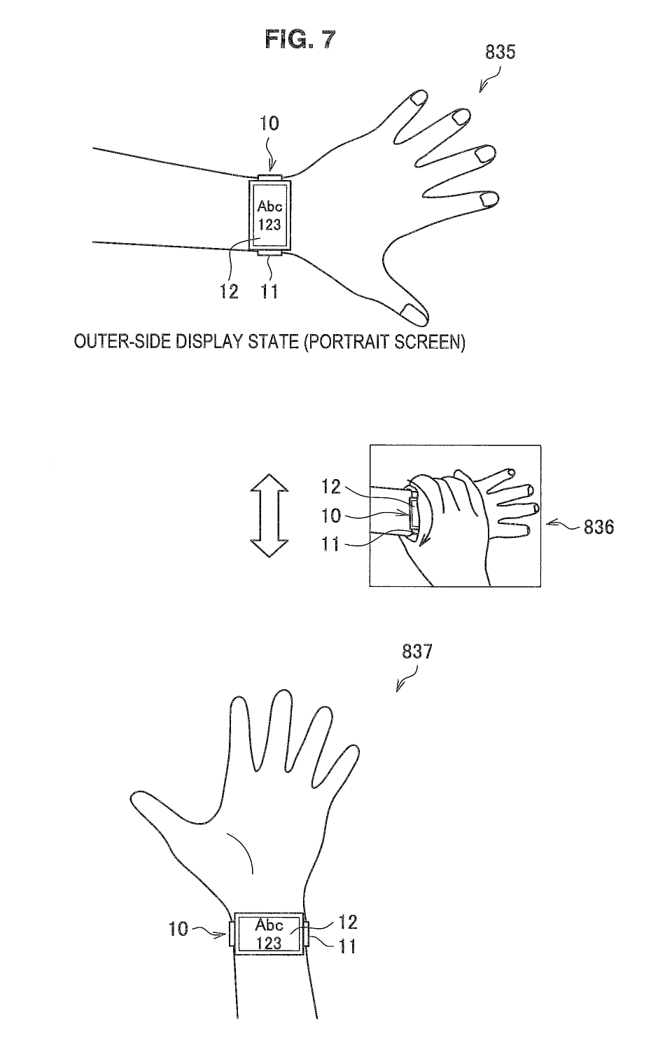

An example of display to be displayed on the display unit 12 in the bracelet-type terminal 10 in which the display unit is located on one side of the arm as shown in FIG. 2 will be first described with reference to FIGS. 6 and 7.

FIG. 6 is a diagram illustrated to describe an example of a portrait view and a landscape view of the display unit 12 of the bracelet-type terminal 10. In this description, the display unit 12 is assumed to be located on the inner side of the arm. In the example of display shown in FIG. 6, the portrait view and the landscape view are switched depending on the posture of the arm. Specifically, in the case of the posture of the arm (horizontal orientation) as shown in the state 831, the display unit 12 performs the portrait view. In the case of the posture of the arm (vertical orientation) as shown in the state 832, the display unit 12 performs the landscape view. This allows for automatic switching to the display orientation that is more easily visible to the user depending on the posture of the arm, and thus the user is able to easily recognize the content displayed on the display unit 12.

In the case of the posture of the arm (vertical orientation) as shown in the state 832, the user wears the bracelet-type terminal 10 on the left arm. If the bracelet-type terminal 10 is worn on the right arm of the user, the side of the bracelet-type terminal 10 used as the upper side to preferably perform the landscape view is reversed. However, even when it is worn on either one of the hands, for example, an acceleration sensor detects the direction of gravitational acceleration acting on the terminal and the direction of gravitational acceleration is displayed to head for the bottom of the screen as shown in the figure, and thus the display that is easily visible to the user may be performed.

FIG. 7 is a diagram illustrated to describe an example of a portrait view and a landscape view of a display unit 12 of the bracelet-type terminal 10. In the state 835 shown in FIG. 7, the display unit 12 is assumed to be located on the outer side of the arm. Then, the user rotates the bracelet-type terminal 10 in the direction indicated by the arrow with his hand as shown in the state 836 and places the display unit 12 to be located on the inner side of the arm as shown in the state 837. In the case of the posture of the arm (horizontal orientation) shown in the state 835, the display unit 12 performs the portrait view. In the case of the posture of the arm (vertical orientation) as shown in the state 837, the display unit 12 performs the landscape view. When the display unit 12 is located on the inner side of the arm and the arm is in horizontal orientation, the display unit 12 performs the portrait view. This allows for automatic switching to the display orientation that is more easily visible to the user depending on the posture of the arm.

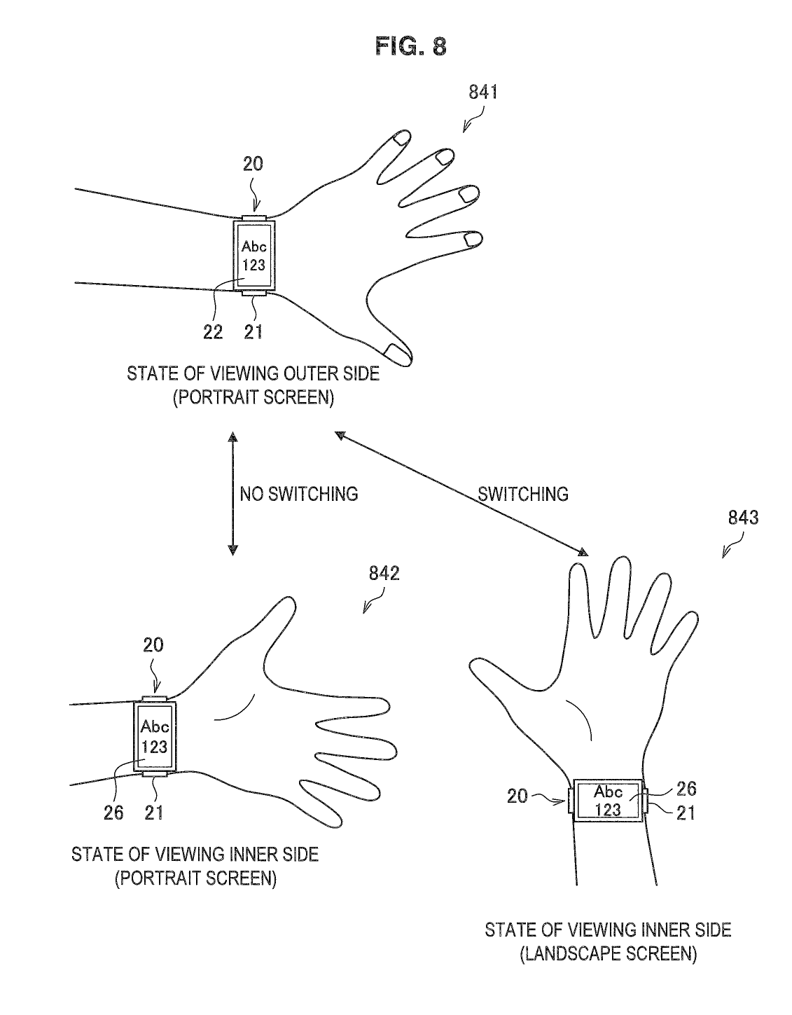

An example of display to be displayed on the first and second display units 22 and 26 in the bracelet-type terminal 20 in which the display units are each located on both sides of the arm as shown in FIG. 3 will be described below with reference to FIG. 8.

FIG. 8 is a diagram illustrated to describe an example of display to be displayed on the first display unit 22 and the second display unit 26 of the bracelet-type terminal 20. As shown in the state 841, the first display unit 22 located on the outer side of the arm is assumed to perform the portrait view. Then, when the arm is turned over to be in the horizontal orientation as shown in the state 842, the second display unit 26 also performs the portrait view. In this case, the second display unit 26 displays the same content as the first display unit 22.

On the other hand, when the arm is moved to be in the vertical orientation as shown in the state 843, the second display unit 26 performs the landscape view. In this case, the second display unit 26 changes the orientation of content displayed on the display unit 22 and then displays the content. The first display unit 22 and the second display unit 26 may perform the display together, but only one of both may perform the display.

### 3-2. Example of Display to be Displayed on Display Unit During Execution of App

An example of display to be displayed on the display unit during execution of an app is described. The following description will be made by taking as an example the first and second display units 22 and 26 of the bracelet-type terminal 20 rather than the bracelet-type terminal 10.

(Mailer App)

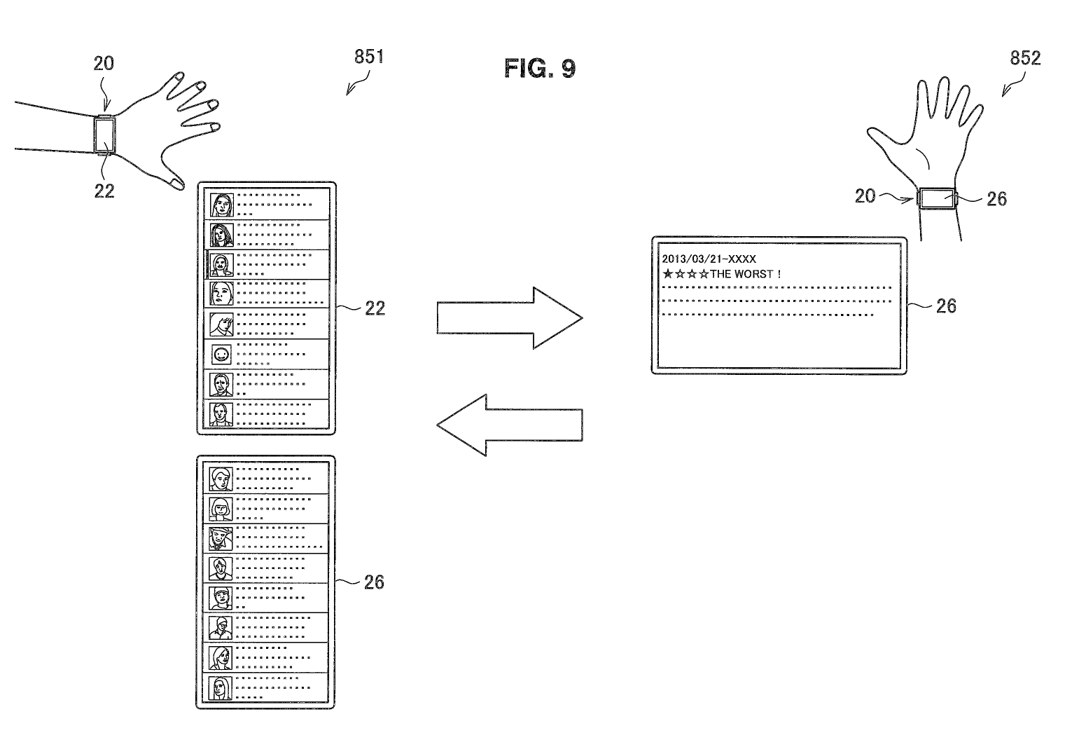

FIG. 9 is a diagram illustrated to describe an example of display to be displayed on the first and second display units 22 and 26 during execution of a mailer app. In this description, as shown in the state 851, the first display unit 22 and the second display unit 26 are assumed to display a top screen that indicates an email list as the portrait view. In such a case, the top screen is able to be displayed using two display units, and thus the increased number of emails may be displayed. The user can view each list displayed on the first display unit 22 and the second display unit 26 by turning over the arm.

In the state 851, if the user selects a desired email on the top screen, the detail screen of the selected email is displayed. In this case, if the body of the email is displayed in portrait orientation, it is difficult for the user to read the email body. Thus, if an email on the top screen displayed in portrait orientation is selected, the second display unit 26 displays the body of the selected email in landscape orientation as shown in the state 852. This allows the email body to be displayed so that the user easily read it. In the state 852, the arm is positioned in vertical orientation to be easy to read the email body.

Transition from the landscape view to be displayed on the email body shown in the state 852 to the portrait view on the top screen shown in the state 851 is performed by the user who operates buttons or the like. However, this is not limited thereto, and for example, if the arm is rotated from the vertical orientation to the horizontal orientation as shown in the state 852, the top screen may be displayed in landscape orientation. In this way, in the state of execution of the app, the user can easily read the text by switching between the portrait view and the landscape view. The above description is made by taking the email body as an example, but the similar control allows the display to be easily view even in the screen transition to display a news topic and the content of news.

In the case of the bracelet-type terminal 10, the display may be controlled as described below. For example, if the user selects a desired email in the list on the top screen displayed in portrait orientation on the display unit 12, the selected body is displayed in portrait orientation. Then, if the user rotates the bracelet-type terminal 10, the email body is switched from the portrait view to the landscape view. This results in the email body being displayed to be easily visible to the user.

(Map App)

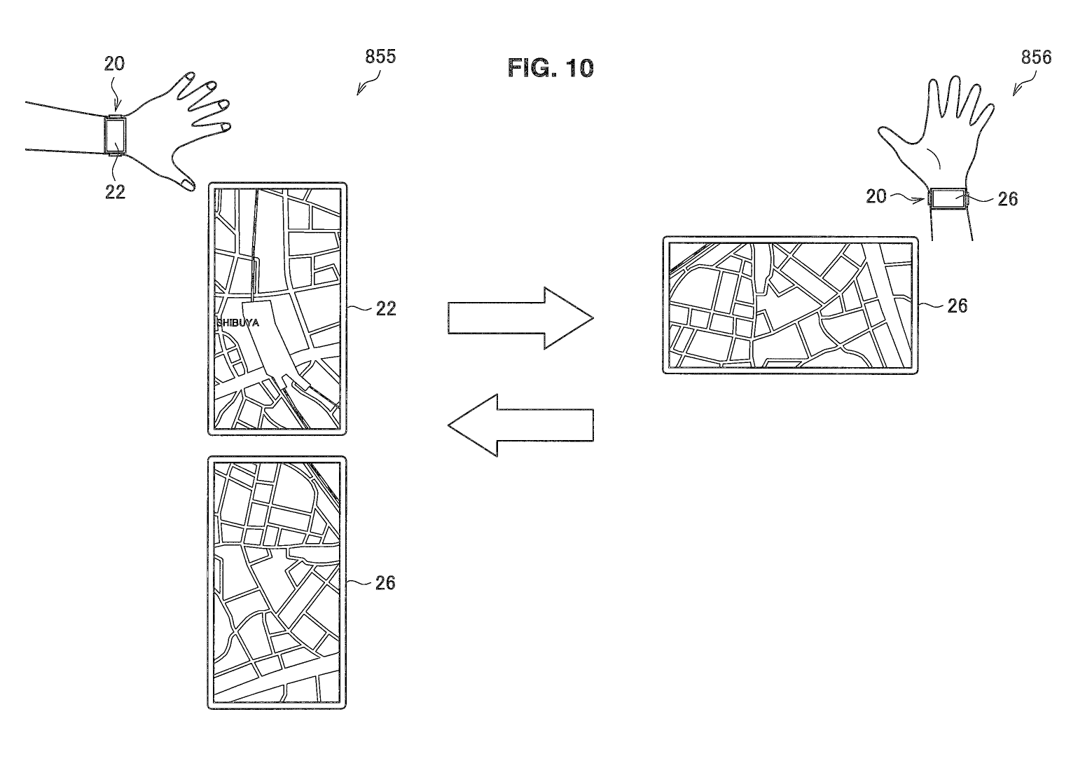

FIG. 10 is a diagram illustrated to describe an example of display to be displayed on the first display unit 22 and the second display unit 26 during execution of a map app. In the map app, a display orientation suitable for the first display unit 22 and the second display unit 26 is made different from each other in accordance with a region on a map in which the user wants to display. For example, if a vertically wide region is intended to be displayed, the arm is moved in horizontal orientation as shown in the state 855 and then the first display unit 22 and the second display unit 26 display the map in portrait orientation.

On the other hand, if a horizontally wide region is intended to be displayed, the arm is moved in vertical orientation as shown in the state 856 and then the second display unit 26 display the map in landscape orientation. This makes it possible for the user to view the map that indicates a desired region by changing the posture of the arm (turn the arm in vertical orientation or horizontal orientation) during execution of a map app.

(Video Player App)

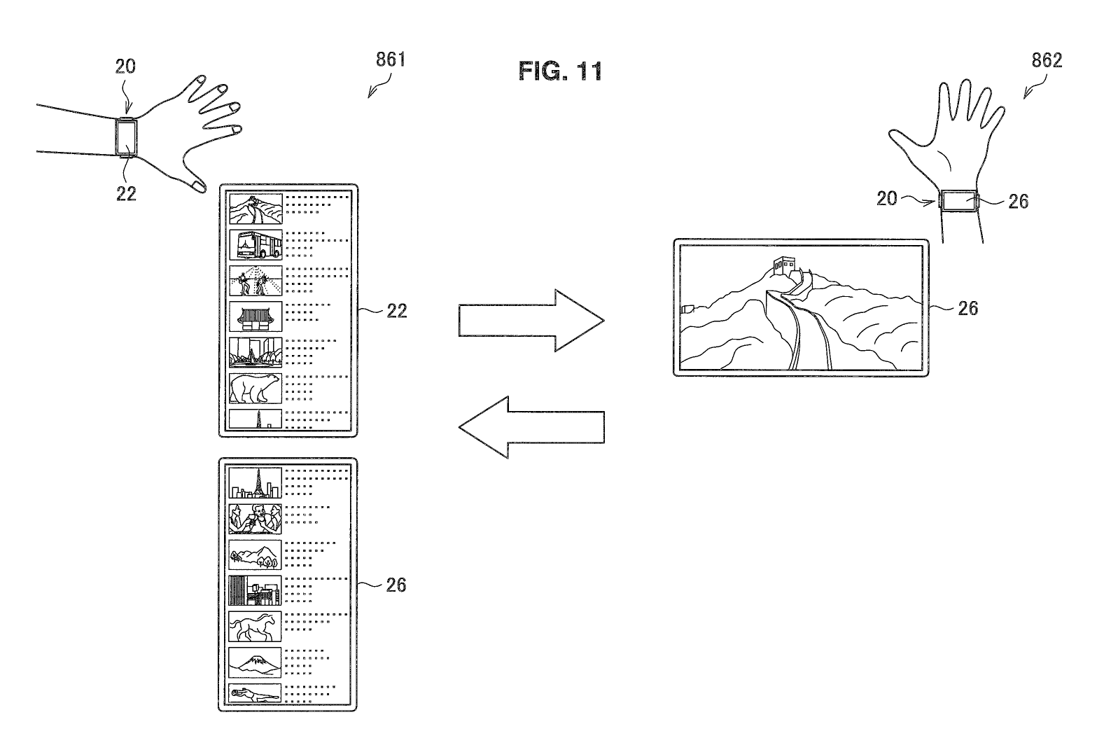

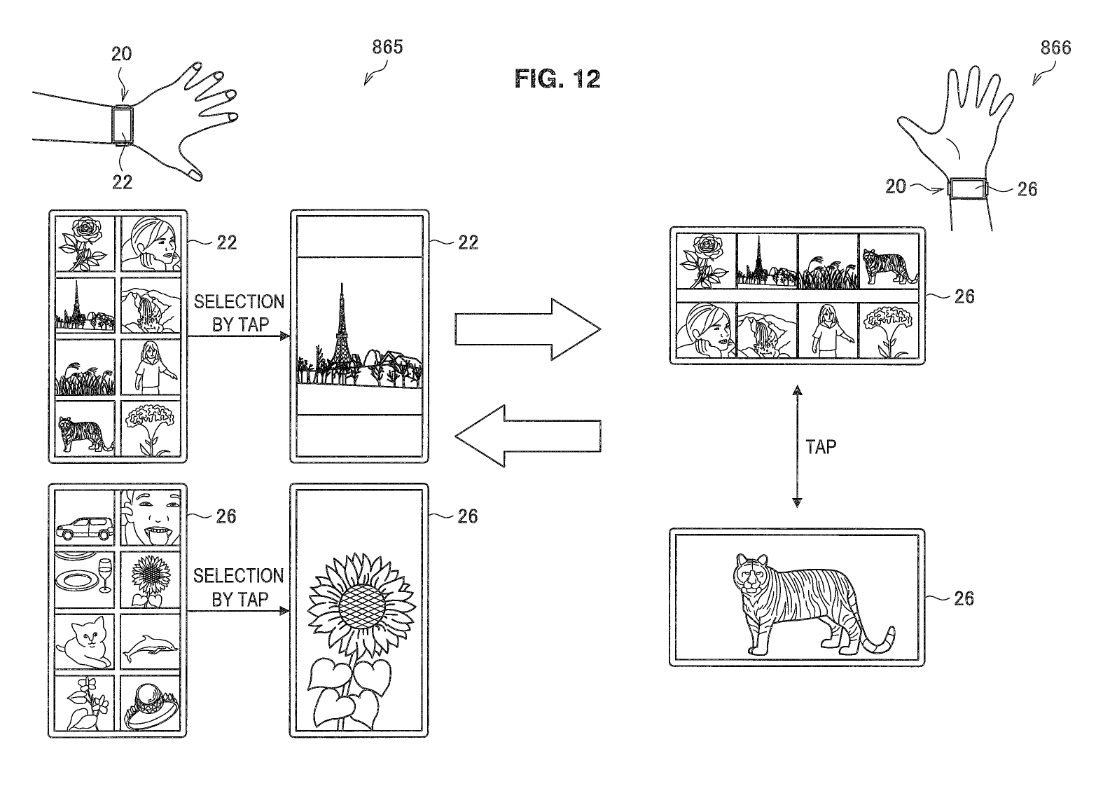

FIG. 11 is a diagram illustrated to describe an example of display to be displayed on the first display unit 22 and the second display unit 26 during execution of a video player app. Video contents are typically suitable for a landscape view. When the video player app is started, the first display unit 22 and the second display unit 26 are displayed in portrait orientation by default as shown in the state 861. In this case, the video contents displayed in portrait orientation are difficult for the user to view.

Thus, if the arm is placed in vertical orientation as shown in the state 862, the second display unit 26 displays a landscape view. This effectively utilizes the landscape screen of the second display unit 26, thereby displaying the increased size of video. Accordingly, the user can comfortably view a video displayed in a suitable orientation.

(Photo Viewer App)

FIG. 12 is a diagram illustrated to describe an example of display to be displayed on the first display unit 22 and the second display unit 26 during execution of a photo viewer app. Photo contents have different suitable display orientations depending on whether a photo to be displayed is a portrait-oriented photo or a landscape-oriented photo. For example, if a portrait-oriented photo is intended to be displayed, the arm is placed in the horizontal direction as shown in the state 865 and thus the first display unit 22 and the second display unit 26 display thumbnails and photos in portrait orientation.

On the other hand, if a landscape-oriented photo is intended to be displayed, the arm is placed in the vertical direction as shown in the state 866 and thus the second display unit 26 displays thumbnails and photos in landscape orientation. This makes it possible to display a photo with the increased size in an easily manner by changing the posture of the arm (turn the arm in vertical orientation or horizontal orientation) during execution of a photo viewer app. Accordingly, the user can view a photo displayed in a suitable orientation.

The display examples during the execution of map app, video player app, and photo viewer app in the bracelet-type terminal 20 have been described in the above, but the bracelet-type terminal 10 also can control display as described in the display example during the execution of the mailer app.

(Modifications)

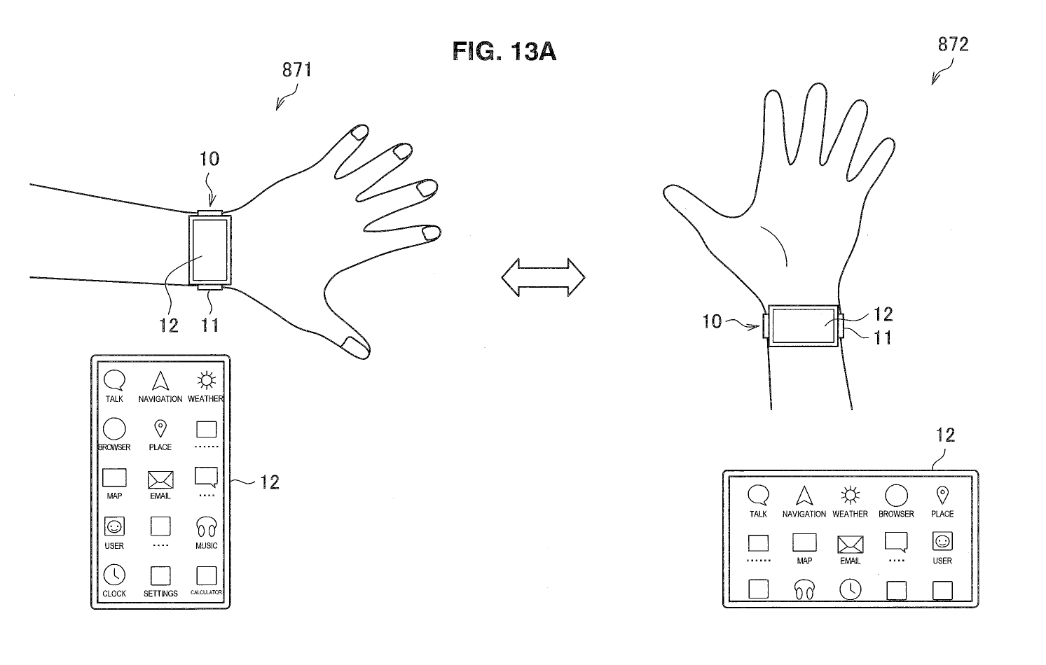

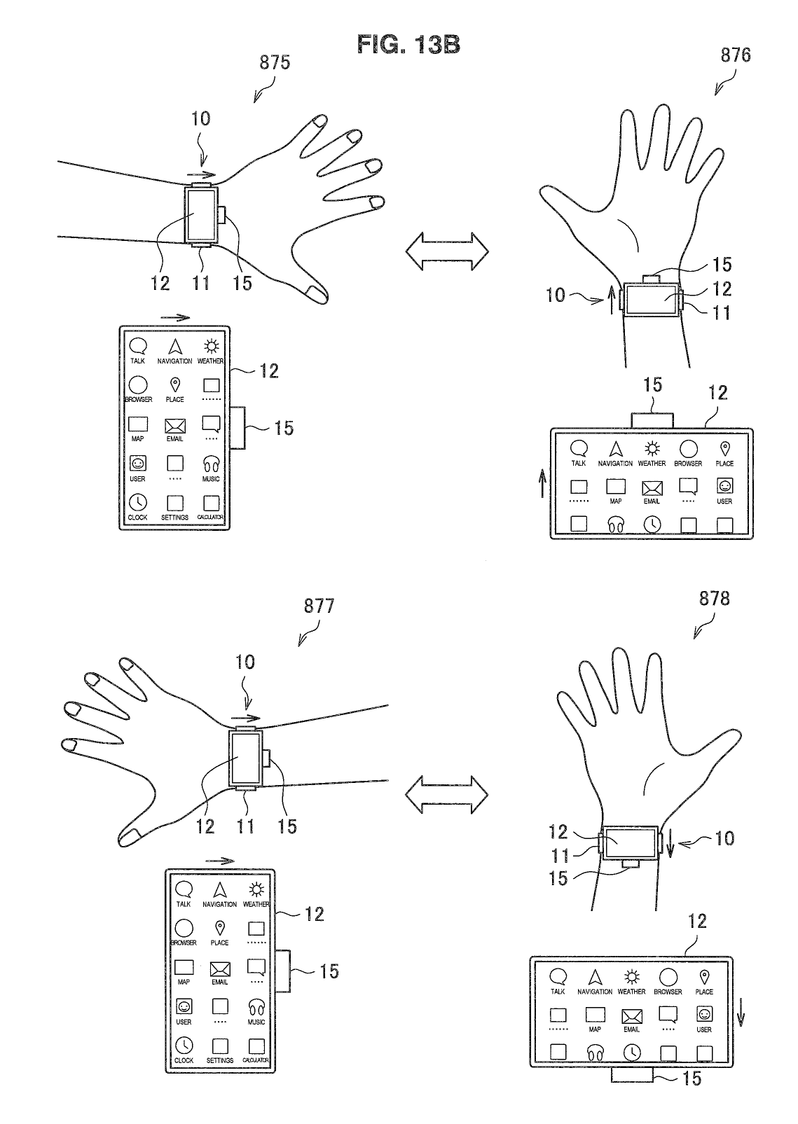

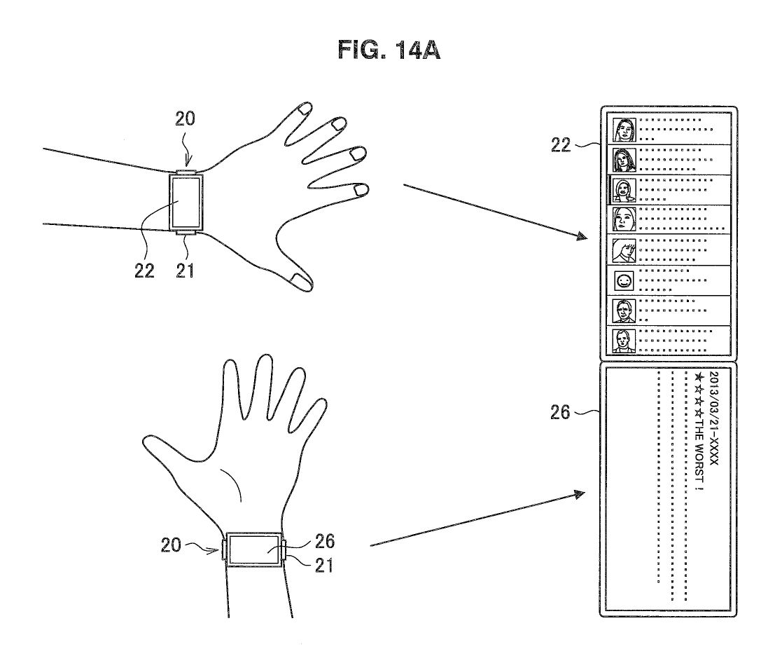

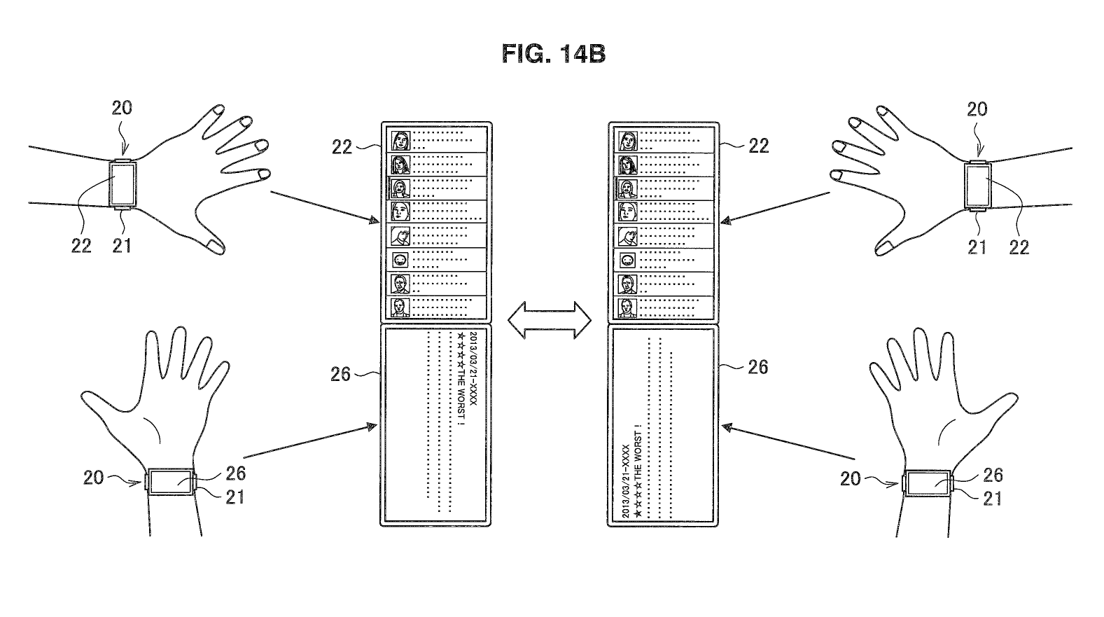

In the above, although the bracelet-type terminal 10 or the bracelet-type terminal 20 switches between a portrait view and a landscape view depending on the type of apps or the posture of the user's arm, but it is not limited thereto. For example, as shown in FIGS. 13A and 14A, the display unit 12 of the bracelet-type terminal 10 or the first and second display units 22 and 26 of the bracelet-type terminal 20 may have a fixed display orientation.

FIG. 13A is a diagram illustrated to describe a modification of display to be displayed on the display unit 12 of the bracelet-type terminal 10. FIG. 13A illustrates a standby screen as an example. In the modification shown in FIG. 13A, when the display unit 12 is located on the outer side of the arm, the display unit 12 typically displays the standby screen in portrait orientation as shown in the state 871. On the other hand, when the display unit 12 is located on the inner side of the arm, the display unit 12 typically displays the standby screen in landscape orientation as shown in the state 872. In this case, even if the arm is placed in horizontal orientation when the display unit 12 is located in the inner side of the arm, the display unit 12 performs the landscape view.

FIG. 14A is a diagram illustrated to describe a modification of display to be displayed on the first display unit 22 and the second display unit 26 of the bracelet-type terminal 20. In FIG. 14A, a screen indicating the email list is displayed on the first display unit 22 located on the outer side of the arm and the body of an email is displayed on the second display unit 26 located on the inner side of the arm. In the modification shown in FIG. 14A, the first display unit 22 typically displays the screen of the list in portrait orientation and the second display unit 26 typically displays the email body in landscape orientation. In other words, the first display unit 22 and the second display unit 26 have the respective fixed display orientations regardless of the posture of the arm.

The email body is suitable for a landscape view that has a larger display region in the horizontal direction. Furthermore, similarly, the landscape view is suitable to display a video of originally landscape-oriented contents such as aspect ratio of 16:9, rather than the portrait view. In this way, it may be considered that the system automatically switches between a landscape view and a portrait view depending on the type of contents regardless of the posture of the arm.

The user can select between the setting of automatic switching of a portrait view and a landscape view of the display unit 12 depending on the posture of the arm as shown in FIG. 6 and the setting of fixing the display orientation of the display unit as shown in FIG. 13A or 14A. This makes it possible to perform display depending on the user's preference.

In the case of a terminal having a screen on one side of the arm as shown in FIG. 2, in order to change the display orientation depending on a position of a display screen with respect to the arm as shown in FIG. 13A, it is necessary to provide a way of determining whether the bracelet-type terminal 10 is located on the inner side or the outer side of the arm. It is conceivable to provide a way of analyzing the moving trajectory of the bracelet-type terminal 10 based on information obtained by an acceleration sensor or a gyro sensor during walking or the up-and-down motion of the arm and estimating whether the terminal is located on the right hand or the left hand and whether the terminal is worn on the inner side or the outer side. In addition, it is conceivable to provide another way of determining whether the terminal is located on the inner side or the outer side of the arm by placing a sensor such as a photo-reflector in the inner side on the circumference and measuring the distance between the outer circumference of the arm and the inner surface of the terminal. Alternatively, it is conceivable to provide the other way as a method for setting explicitly whether the terminal is worn on the inner side or the outer side using a setting menu or the like in a screen by the user.

When considering such a case, as shown in FIG. 13B, even if a screen is similarly located on the inner side of the arm, the orientation of a screen to be displayed is reversed based on whether the bracelet-type terminal 10 is worn on the left hand or the right hand. Thus, a way of determining whether the terminal is worn on the right hand or the left hand may be provided in addition to the way of determining whether the terminal is located on the inner side or the outer side of the arm, and thus the display orientation can be controlled in a more appropriate manner. The bracelet-type terminal 10 is provided with a power button 15 on one side thereof as shown in FIG. 13B. For example, the user may select a setting menu on a screen as a way of determining whether the terminal is worn on the right hand or the left hand. In this case, for example, it is conceivable to provide four items “left hand and outer side”, “left hand and inner side”, “right hand and outer side”, and “right hand and inner side” as a setting item used to set a state where the terminal is worn.

Moreover, in each state (states 875 to 878) of the arm in FIG. 13B, the user may be likely to wear the terminal in the direction vertically or horizontally opposite to the direction shown in the figure. Thus, only one direction of four directions of top, bottom, left, and right of the terminal may be simply defined as the “top” during the display without distinction of right, left, inner, and outer, and this is used as a selectable item of the setting menu.

In addition, as shown in FIG. 14A, even when where the portrait view is performed in a typical case but the landscape view is performed for particular contents such as the body of an email or a video, as shown in FIG. 14B, the display orientation in the landscape view may be reversed vertically depending on whether the bracelet-type terminal 20 is worn on the left hand or the right hand. Thus, even when the display control as shown in FIG. 14A is performed, a way of determining whether a terminal is worn on the right hand or the left hand is provided, and thus the display orientation can be controlled in more appropriate manner. The selection of a setting menu on a screen by the user may be used as a way of determining whether a terminal is worn on the right hand or the left hand. There are two items of “wearing on left hand” and “wearing on right hand” as a selectable item of a setting menu in cases described above. In addition, in a similar way to the case of FIG. 13A described above, any one side of the terminal may be simply defined as the “top” during the landscape orientation display without distinction of left and right, and this is used as a selectable item of the setting menu.

As described above, in the bracelet-type terminal 10 or the bracelet-type terminal 20 according to the present embodiment, switching of a display unit is performed between the portrait view and the landscape view depending on the position of a display unit corresponding to the posture of the arm. Accordingly, the display that is more easily visible to the user is implemented.

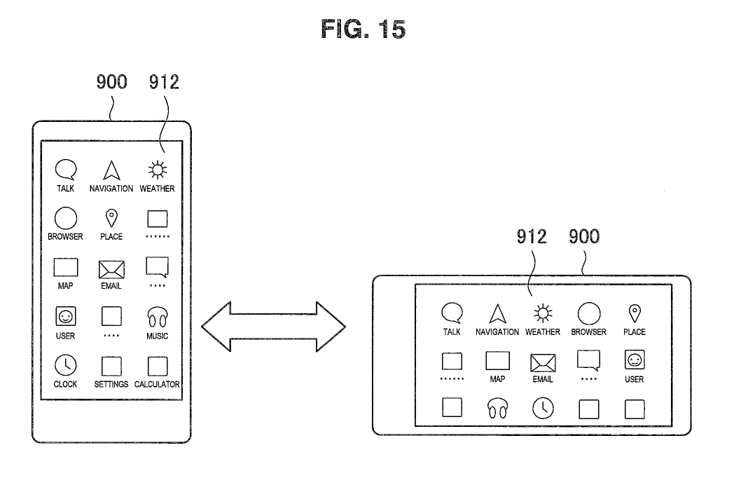

However, the detection of motion of the terminal with a sensor and the change in the orientation of a screen are similar in some extent to the rotation of a screen that is implemented in a smartphone 900 or the like as shown in FIG. 15. In other words, a display unit 912 of the smartphone 900 is changed from vertical to horizontal orientation, and thus the screen orientation of the display unit 912 is also changed from vertical to horizontal orientation. Meanwhile, in the present embodiment, the orientation of the display unit 12 (first and second display units 22 and 26) is changed by detecting the change in the outer and inner wearing in addition to the change in vertical and horizontal orientations of a display unit. FIG. 15 is a diagram illustrating the smartphone 900 according to a comparative example.

More specifically, for example, in a state where a screen of the smartphone 900 is horizontal with respect to the ground, when the display orientation of the screen is intended to be changed and the orientation of the terminal is changed, for example, a change in the gravitational acceleration of a sensor does not occur, and thus the display orientation of the screen is not changed. Meanwhile, in the bracelet-type terminal 10 according to the present embodiment, in a state where the screen is horizontal with respect to the ground, when the display orientation of the screen is intended to be changed and the orientation of the terminal is changed, a change in the gravitational acceleration of a sensor due to an operation for reversal does occur, and thus it is possible to accurately detect the user's intention to rotate. Accordingly, the display orientation of a screen can be accurately changed.

Furthermore, as described above, even if a screen is horizontal with respect to the ground, it is possible to detect accurately the user's intention to rotate. Although the method of switching between a portrait view and a landscape view depending on the difference in the posture of the arm has been described with reference to FIG. 6, when the screen is horizontal at the time of turning on the screen, the gravitational acceleration of a sensor is different between a case where the user intends to display a portrait view and a case where the user intends to display a landscape view, and thus it is difficult to determine the user's intention (in this regard, it is conceivable to depress a switch or tap a screen as a trigger to turn on a screen). However, before turning on a screen, a change in the posture of the bracelet-type terminal 10 is detected by an acceleration sensor, a gyro sensor, and so on, and thus the pattern of trajectories of the bracelet-type terminal 10 may be detected. Accordingly, it is possible to determine whether the state of the bracelet-type terminal 10 with respect to the body of the user is in horizontal orientation as shown in the upper view of FIG. 6 or in vertical orientation as shown in the lower view of FIG. 6, based on the pattern of trajectories. Consequently, even when a screen is horizontal at the time of turning on the screen, it is possible to display the screen in the orientation suitable for the posture taken by the user, similarly to the case described in FIG. 6.

### 3-3. Example of Display in Consideration of Degree of Privacy

The bracelet-type terminal 10 and the bracelet-type terminal 20 according to the present embodiment perform display in consideration of the degree of privacy to reduce the risk of information with a high degree of privacy being viewed by others. An example of display to be performed by the bracelet-type terminal 20 using the degree of privacy will be described, and then an example of display to be performed by the bracelet-type terminal 10 using the degree of privacy will be described.

(Example of Display Performed by Bracelet-Type Terminal 20)

An example of display to be displayed on the first and second display units 22 and 26 of the bracelet-type terminal 20 when the bracelet-type terminal 20 receives a newly arrived email will be first described.

When the bracelet-type terminal 20 receives a newly arrived email, the first display unit 22, which is located on the outer side of the arm, displays information with a low degree of privacy that can be recognized immediately, such as the sender and title of the newly arrived email, and the second display unit 26, which is located on the inner side of the arm, displays the body of the newly arrived email. It is desirable for the user to optionally set content to be displayed on the first display unit 22.

In ordinary activities of daily life, the inner side of the wrist of a person is difficult to be viewed by others, and thus privacy can be protected by allowing the second display unit 26 to display the email body. In addition, the first display unit 22 displays the sender and title of an email and thus the user who receives notification of a newly arrived email can easily check the email body immediately.

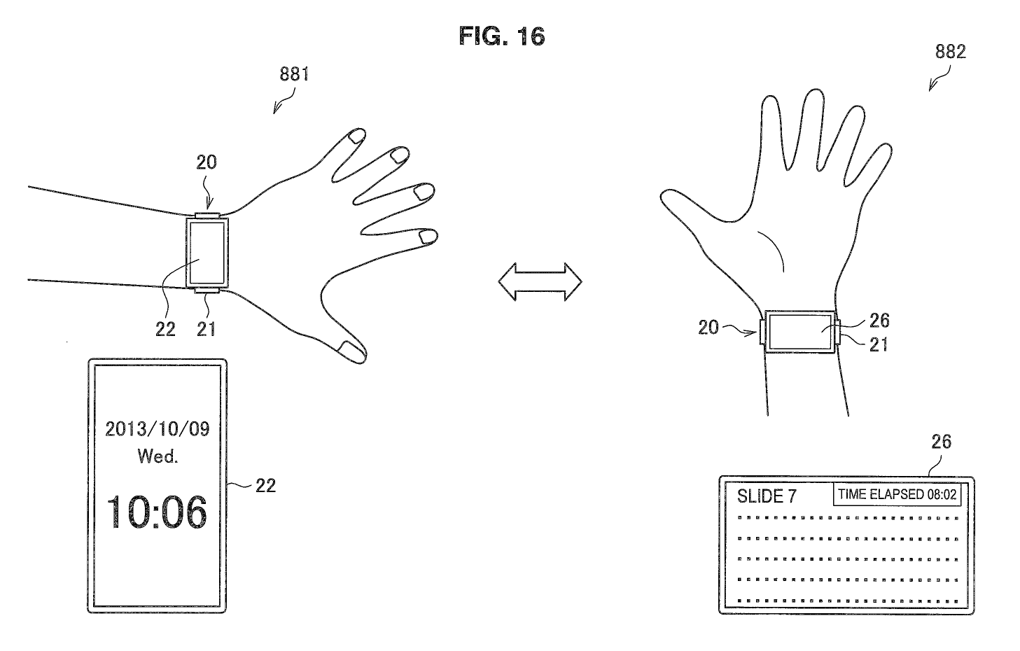

An example of display to be displayed on the first and second display units 22 and 26 of the bracelet-type terminal 20 in a meeting or presentation will be described with reference to FIG. 16.

FIG. 16 is a diagram illustrated to describe an example of display to be displayed on the first display unit 22 and the second display unit 26 of the bracelet-type terminal 20 in a meeting or presentation. In FIG. 16, the first display unit 22, which is located on the outer side of the arm, displays information with a low degree of privacy (for example, clock display) that is acceptable to be viewed by others, as shown in the state 881. On the other hand, the second display unit 26, which is located on the inner side of the arm, displays information with a high degree of privacy (for example, a note about what to talk) that is not wanted to be viewed by other people, as shown in the state 882.

Thus, in cases where the hand is a natural state such as when the user makes a note or when the user works using a personal computer during a meeting or presentation, the outer side is directed to the other party, but if the user wants to check the inner side, the user can check the content immediately by turning the wrist inward without a particular tap or swipe operation. In addition, it is possible to display typically contents that are acceptable to be viewed by others such as clock display and that the user itself wants to check.

The second display unit 26 may perform a display, for example, only when the user performs a specific gesture (as an example, a gesture to show the back of the hand to the other party to whom presentation is made as shown in the state 882 of FIG. 16). The second display unit 26 may perform display only when it is detected that the user is looking at the inner side of the arm by face detection using a camera or other like device disposed around the second display unit 26. In this case, it is possible to prevent information with a high degree of privacy from being viewed by others in a more effectively manner.

(Example of Display Performed by Bracelet-Type Terminal 20)

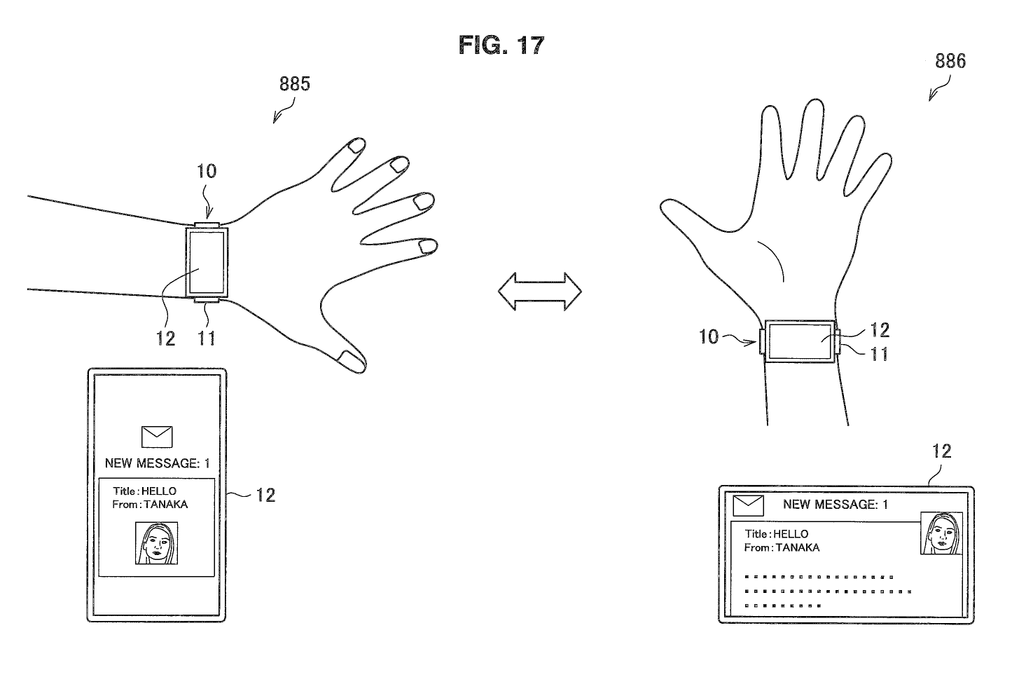

An example of display depending on the position of the display unit 12 of the bracelet-type terminal 10 upon receipt of email will be described with reference to FIG. 17.

FIG. 17 is a diagram illustrated to describe an example of display depending on the position of the display unit 12 of the bracelet-type terminal 10 upon receipt of email. In FIG. 17, content to be displayed on the display unit 12 upon receipt of email varies depending on the position at which the display unit 12 is attached to the arm.

For example, as shown in the state 885, when the display unit 12 is located on the outer side of the arm, upon receipt of email, the display unit 12 displays information with a low degree of privacy that can be recognized immediately such as the sender and title of the arrived email. At this time, these types of information have small number of characters and thus the display unit 12 performs a portrait view. Then, when the user performs a tap operation on a screen, the display unit 12 displays the email body with a high degree of privacy. As a result, upon receipt of email, it is possible to prevent the email body with a high degree of privacy from being viewed by others contrary to the user's intention.

On the other hand, as shown in the state 886, when the display unit 12 is located on the inner side of the arm, upon receipt of email, the display unit 12 displays the email body from the beginning in addition to information of the sender and title. At this time, the display unit 12 performs a landscape view to make the email body easier to view. This makes it possible to omit the operation performed by the user such as a tapping for displaying the email body. In addition, the display unit 12 is located on the inner side of the arm, and thus even when the email body is displayed upon receipt of email, the risk of being viewed by others is reduced.

### 3-4. Animation in Case of Switching between Portrait and Landscape Views

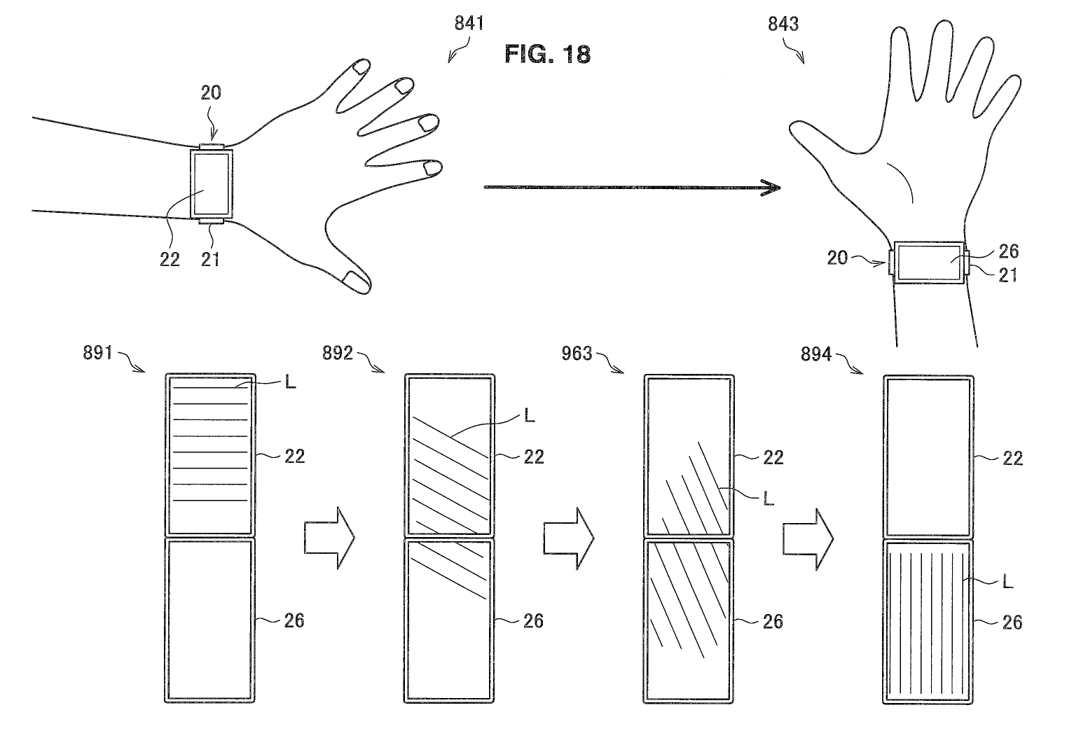

The bracelet-type terminal according to the present embodiment performs a transition animation to make the displayed content easier to view by the user in case of switching between a portrait view and a landscape view. An animation in case of switching from a portrait view on the first display unit 22 of the state 841 described above with reference to FIG. 8 to a landscape view on the second display unit 26 of the state 843 will be described with reference to FIG. 18.

FIG. 18 is a schematic diagram illustrated to describe an example of an animation in case of switching from a portrait view to a landscape view. In FIG. 18, as shown in the state 841, the arm is in horizontal orientation. In this case, it is assumed that the first display unit 22 displays a portrait view while the second display unit 26 does not display anything (state 891). In this case, the text displayed on the first display unit 22 is arranged in horizontal orientation shown by the line L.

Then, the user changes the posture of the arm by turning the arm from horizontal orientation to vertical orientation (state 843). With the change in the posture, display on the first and second display units 22 and 26 is shifted like the states 892 to 894. In other words, the text arranged in horizontal orientation on the first display unit 22 is gradually tilted and finally they are arranged in a state of being rotated by 90 degrees.

In such a case, in switching from a portrait view on the first display unit 22 to a landscape view on the second display unit 26, the content displayed as an animation typically faces the point of view of the user. Thus, even in the middle of rotation of the arm by the user, the user can appropriately recognize the content displayed on the first and second display units 22 and 26.

Although an animation in case of switching from a portrait view on the first display unit 22 to a landscape view on the second display unit 26 has been described above, this is similarly applicable to an animation in case of switching from a landscape view to a portrait view.

### 4. Operation of Display Control Apparatus

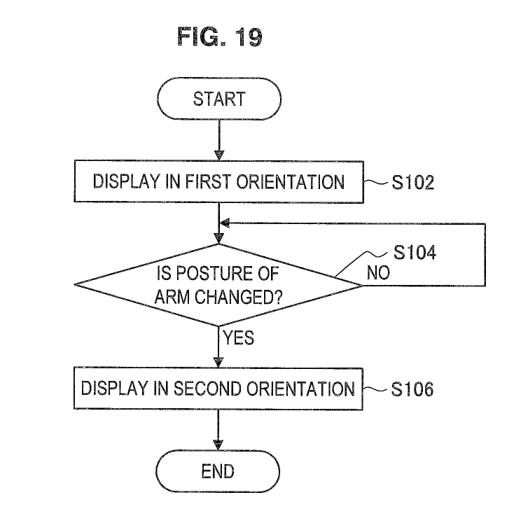

An example of the operation performed by a display control apparatus 100 in case of switching the display orientation of a display unit will be described with reference to FIG. 19. The description is given by taking the first and second display units 22 and 26 of the bracelet-type terminal 20 as an example.

FIG. 19 is a flowchart illustrating an exemplary operation performed by the display control apparatus 100 in case of switching the display orientation of a display unit. The process illustrated in FIG. 19 is implemented by a CPU of the display control apparatus 100 executing programs stored in a ROM. Programs to be executed may be stored in a recording medium such as compact disks (CDs), digital versatile disks (DVDs), and memory cards, or may be downloaded from a server or the like via the Internet.

The flowchart of FIG. 19 starts from a state where an application such as a mailer app is run and the first display unit 22 performs display in a first orientation (step S102). In this step, it is assumed that the display in the first orientation is a portrait view and the first display unit 22 displays, for example, an email list.

Then, the posture detection unit 110 detects whether the posture of the arm on which the bracelet-type terminal 20 is worn is changed (step S104). For example, the posture detection unit 110 detects whether the posture of the arm is changed from horizontal orientation to vertical orientation after the user selects a desired email from the list displayed on the first display unit 22. Then, if no change in the posture is detected in step S104 (NO), the controller 120 keeps the portrait view on the first display unit 22.

On the other hand, if a change in the posture is detected in step S104 (YES), the controller 120 switches from the portrait view on the first display unit 22 to the landscape view on the second display unit 26 (step S106). In other words, the second display unit 26 displays the body of an email in a landscape view. This makes it possible for the user to easily recognize content of the body of the email selected from the list.

### 5. Hardware Configuration

The operation performed by the display control apparatus 100 described above is implemented by cooperation of the hardware structures and software provided in the display control apparatus 100. The hardware configuration of the display control apparatus 100 will be described.

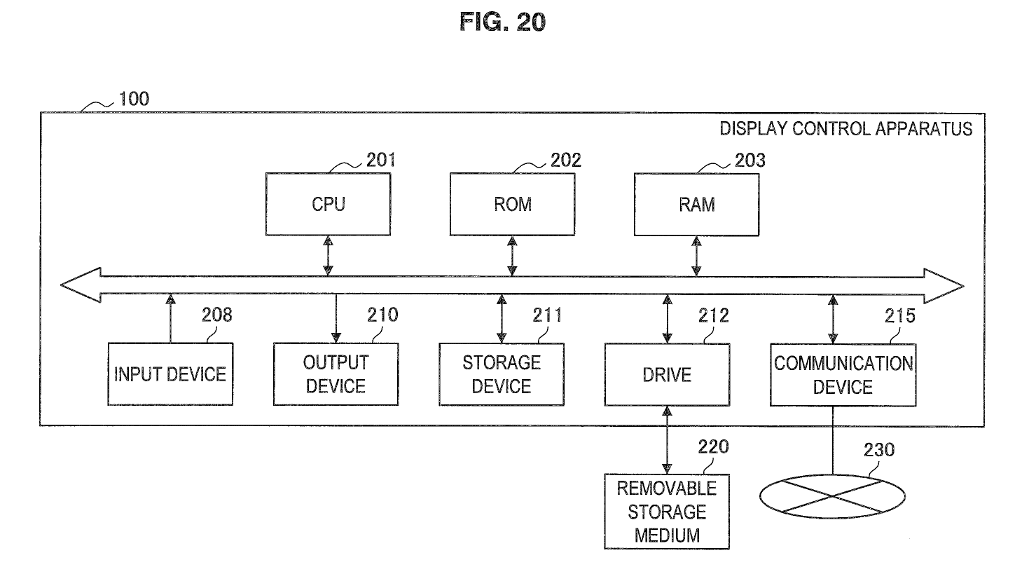

FIG. 20 is a diagram illustrated to describe an exemplary hardware configuration of the display control apparatus 100 according to an embodiment. As illustrated in FIG. 20, the display control apparatus 100 is configured to include a central processing unit (CPU) 201, a read only memory (ROM) 202, a random access memory (RAM) 203, an input device 208, an output device 210, a storage device 211, a drive 212, and a communication device 215.

The CPU 201 serves as an operation processing unit and control device, and controls the overall operation in the display control apparatus 100 in accordance with various types of programs. The CPU 201 may also be a microprocessor. The ROM 202 stores a program used by the CPU 201, an operational parameter, or the like. The RAM 203 temporarily stores a program used in the execution of the CPU 201, a parameter varying appropriately in the execution thereof, or the like. These components are connected to each other through a host bus including a CPU bus or the like.

The input device 208 is configured to include, for example, an input mechanism and an input control circuit. The input mechanism is used to allow the user to input information and includes a mouse, a keyboard, a touch panel, a touchpad, a button, a microphone, a switch, and a lever. The input control circuit generates an input signal based on an input made by the user and outputs the generated signal to the CPU 201. The user of the display control apparatus 100 can operate the input device 208 to allow various data to be inputted to the display control apparatus 100 or instruct the display control apparatus 100 to perform a processing operation.

The output device 210 includes a display device such as a liquid crystal display (LCD) device, an organic light emitting diode (OLED) device, and a lamp. Furthermore, the output device 210 includes an audio output device such as a speaker and a headphone. For example, the display device displays a captured image, a generated image, or the like. The audio output device converts audio data or the like into a sound and outputs the sound.

The storage device 211 is a device for data storage, which is configured as an example of a storage unit included in the display control apparatus 100 according to the present embodiment. The storage device 211 may include a storage medium, a recording device for recording data on a storage medium, a readout device for reading out data from a storage medium, and a deletion device for deleting data stored on a storage medium. The storage device 211 stores a program executed by the CPU 201 and various types of data.

The drive 212 is a reader-writer for a storage medium and is embedded in, or externally attached to, the display control apparatus 100. The drive 212 reads out information recorded on a removable storage medium 220 that is attached thereto, such as a magnetic disk, an optical disk, a magneto-optical disk, or a semiconductor memory, and outputs the information to the RAM 203. In addition, the drive 212 is also able to write information to the removable storage medium 220.

The communication device 215 may be a communication interface including a communication device or the like used to connect to a network 230. In addition, the communication device 215 may be a wireless local area network (LAN) compatible communication device, a long-term evolution (LTE) compatible communication device, or a wired communication device that performs communication by wire.

The network 230 is a wired or wireless transmission path for information transmitted from an apparatus that is connected to the network 230. For example, the network 230 may include public networks such as the Internet, telephone network, and satellite communication network, various local area networks (LANs) including Ethernet (registered trademark), and wide area networks (WANs). In addition, the network 230 may include a leased line network such as internet protocol-virtual private network (IP-VPN).

### 6. Conclusion

According to an embodiment described above, a portrait view and a landscape view on the display unit are appropriately switched in the bracelet-type terminals 10 and 20 depending on the posture of the arm, and thus the user can easily view the content displayed on the display unit. In particular, the display orientation is automatically switched depending on detection by a sensor and the displayed content, and thus the user can view the content displayed in a desired orientation without any user's operation.

Moreover, information with a low degree of privacy is displayed on the display unit located on the outer side of the arm and information with a high degree of privacy is displayed on the display unit located on the inner side of the arm, and thus this division makes it possible to prevent information with a high degree of privacy from being viewed by others.

It should be understood by those skilled in the art that various modifications, combinations, sub-combinations and alterations may occur depending on design requirements and other factors insofar as they are within the scope of the appended claims or the equivalents thereof.

Note that the advantages mentioned herein are to be considered illustrative or exemplary rather than restrictive. The technology according to the embodiments of the present disclosure can provide other advantages apparent to those skilled in the art from the description given herein, in addition to or as an alternative to the above advantages.

Additionally, the present technology may also be configured as below:

(1) A display control apparatus including:
a controller configured to control display on a display device worn on an arm of a user,
wherein the controller acquires position information indicative of a position of a display region for display in the display device and controls display on the display region depending on the acquired position information.

(2) The display control apparatus according to (1), wherein the controller acquires position information indicative of a position of the display region with respect to the arm and controls the display depending on the position of the display region with respect to the arm.

(3) The display control apparatus according to (1) or (2), wherein the controller acquires rotation information regarding rotation of the arm and controls the display depending on a rotation position of the arm.

(4) The display control apparatus according to any one of (1) to (3), wherein the controller controls a display orientation of the display region depending on the acquired position information.

(5) The display control apparatus according to (4),
wherein the display region has a rectangular shape, and
wherein the controller switches a display orientation between a first orientation along a longitudinal direction of the display region and a second orientation along a short-length direction of the display region depending on the acquired position information.

(6) The display control apparatus according to (5), wherein the controller allows an orientation of display to be changed in a stepwise manner upon switching of display between the first orientation and the second orientation.

(7) The display control apparatus according to any one of (4) to (6),
wherein the display region includes a first display region and a second display region opposite to the first display region as viewed from the arm, and
wherein the controller makes a display orientation of the first display region different from a display orientation of the second display region depending on the acquired position information.

(8) The display control apparatus according to any one of (1) to (7), wherein the controller controls content being displayed on the display region depending on the acquired position information.

(9) The display control apparatus according to (8), wherein the controller makes content being displayed on the display region located on a first side as viewed from the arm different from content being displayed on the display region located on a second side opposite to the first side as viewed from the arm.

(10) The display control apparatus according to (9), wherein the display region is provided on one side as viewed from the arm.

(11) The display control apparatus according to any one of (1) to (3),
wherein the display region includes a first display region and a second display region located on an opposite side of the first display region as viewed from the arm, and
wherein the controller makes content being displayed on the first display region different from content being displayed on the second display region depending on the acquired position information.

(12) The display control apparatus according to (11), wherein the controller allows content related to content being displayed on the first display region to be displayed on the second display region.

(13) A display control method including:
acquiring position information indicative of a position of a display region for display in a display device worn on an arm of a user; and
controlling display on the display region by a processor depending on the acquired position information.

(14) A program for causing a computer to execute:
acquiring position information indicative of a position of a display region for display in a display device worn on an arm of a user; and
controlling display on the display region depending on the acquired position information.

(15) A display device including:
a display region for display; and
a controller configured to control display on the display region,
wherein the display device is worn on an arm of a user, and
wherein the controller acquires position information indicative of a position of the display region in the display device and controls display on the display region depending on the acquired position information.

What is claimed is:

1. A display control apparatus comprising:
a controller configured to control display on a display device worn on an arm of a user,
wherein the controller acquires position information indicative of a position of a display region for display in the display device and controls display on the display region depending on the acquired position information.

2. The display control apparatus according to claim 1, wherein the controller acquires position information indicative of a position of the display region with respect to the arm and controls the display depending on the position of the display region with respect to the arm.

3. The display control apparatus according to claim 1, wherein the controller acquires rotation information regarding rotation of the arm and controls the display depending on a rotation position of the arm.

4. The display control apparatus according to claim 1, wherein the controller controls a display orientation of the display region depending on the acquired position information.

5. The display control apparatus according to claim 4,
wherein the display region has a rectangular shape, and
wherein the controller switches a display orientation between a first orientation along a longitudinal direction of the display region and a second orientation along a short-length direction of the display region depending on the acquired position information.

6. The display control apparatus according to claim 5, wherein the controller allows an orientation of display to be changed in a stepwise manner upon switching of display between the first orientation and the second orientation.

7. The display control apparatus according to claim 4,
wherein the display region includes a first display region and a second display region opposite to the first display region as viewed from the arm, and
wherein the controller makes a display orientation of the first display region different from a display orientation of the second display region depending on the acquired position information.

8. The display control apparatus according to claim 1, wherein the controller controls content being displayed on the display region depending on the acquired position information.

9. The display control apparatus according to claim 8, wherein the controller makes content being displayed on the display region located on a first side as viewed from the arm different from content being displayed on the display region located on a second side opposite to the first side as viewed from the arm.

10. The display control apparatus according to claim 9, wherein the display region is provided on one side as viewed from the arm.

11. The display control apparatus according to claim 1,
wherein the display region includes a first display region and a second display region located on an opposite side of the first display region as viewed from the arm, and
wherein the controller makes content being displayed on the first display region different from content being displayed on the second display region depending on the acquired position information.

12. The display control apparatus according to claim 11, wherein the controller allows content related to content being displayed on the first display region to be displayed on the second display region.

13. A display control method comprising:
acquiring position information indicative of a position of a display region for display in a display device worn on an arm of a user; and
controlling display on the display region by a processor depending on the acquired position information.

14. A program for causing a computer to execute:
acquiring position information indicative of a position of a display region for display in a display device worn on an arm of a user; and
controlling display on the display region depending on the acquired position information.

15. A display device comprising:
a display region for display; and
a controller configured to control display on the display region,
wherein the display device is worn on an arm of a user, and
wherein the controller acquires position information indicative of a position of the display region in the display device and controls display on the display region depending on the acquired position information.
